(19) United States
(12) Patent Application Publication
(10) Pub. No.: US 2010/0090854 A1
(43) Pub. Date: Apr. 15, 2010

(54) MOBILE APPARATUS AND OPERATING METHOD THEREOF

(75) Inventor: Ming Yin, Shanghai (CN)

Correspondence Address: J C PATENTS, 4 VENTURE, SUITE 250, IRVINE, CA, 92618, US

(73) Assignee: INVENTEC APPLIANCES CORP., Taipei (TW)

(21) Appl. No.: 12/573,294

(22) Filed: Oct. 5, 2009

(30) Foreign Application Priority Data
Oct. 14, 2008 (TW) 97139398

(51) Int. Cl. G06F 13/42; G06F 3/041; G08B 21/00

(52) U.S. Cl. 340/686.6; 345/173; 340/825

(57) ABSTRACT

A mobile apparatus and an operating method thereof are provided. According to the present invention, a sensor is installed in the mobile apparatus, and the sensor and a receiver are installed on the same side of the mobile apparatus. The sensor is used to detect whether an object exists within a predetermined distance or not and to generate a corresponding signal. Afterward, a touch unit is disabled or enabled according to the corresponding signal.

### CROSS-REFERENCE TO RELATED APPLICATION

This application claims the priority benefit of Taiwan application serial no. 97139398, filed on Oct. 14, 2008. The entirety of the above-mentioned patent application is hereby incorporated by reference herein and made a part of this specification.

### BACKGROUND OF THE INVENTION

1. Field of the Invention

The present invention relates to a method of operating a mobile apparatus and particularly relates to a method of controlling a display unit in the mobile apparatus.

2. Description of Related Art

As mobile communication becomes more and more widely-used, mobile phone is becoming an electronic product indispensible to people's life nowadays. In recent years, mobile phones are developed to provide miscellaneous functions. In particular, mobile phones having touch screens are attracting the attention of the public. As time goes on, the costs of touch-screen mobile phones are reducing, and touch-screen mobile phones will gradually become the main trend in the market.

In terms of smart phone, most smart phones are equipped with liquid crystal display modules (LCM), and the liquid crystal display module has a touch panel thereon. The touch panel allows the user to more conveniently and instinctively operate the mobile phone.

However, a problem comes along with the convenience of mobile phones. When the user nestles his ear to the mobile phone during phone call, if the user's ear is so close to the touch panel and touches the touch panel, the touch panel may be unintentionally activated to execute other operations, which may cause unnecessary trouble to the user. The aforementioned trouble is, for example, mistakenly turning on or turning off some programs.

### SUMMARY OF THE INVENTION

The present invention provides a mobile apparatus, which includes a sensor that is disposed on the same side as a receiver for detecting whether an object exists within a predetermined distance or not.

The present invention provides a method of operating a mobile apparatus, and the method utilizes a sensor to determine whether to enable or disable a touch unit.

The present invention provides a mobile apparatus, which includes a touch unit and a sensor. Further, the sensor is coupled to the touch unit, and the sensor and a receiver of the mobile apparatus are disposed on the same side. When the sensor detects that an object is within a predetermined distance, the sensor generates a first signal to disable the touch unit. When no object is detected within the predetermined distance, the sensor generates a second signal to enable the touch unit.

In one embodiment of the present invention, the mobile apparatus further includes a controller. The controller is coupled between the touch unit and the sensor to receive the first signal and the second signal transmitted by the sensor for disabling or enabling the touch unit. In addition, the mobile apparatus further includes a switch. The switch is coupled between the touch unit and the sensor. When receiving the first signal, the switch turns off a connection between the touch unit and a power source to disable the touch unit. When receiving the second signal, the switch turns on the connection between the touch unit and the power source to enable the touch unit.

In one embodiment of the present invention, the touch unit provides a touch-control function that is disabled or enabled according to the first signal and the second signal.

In one embodiment of the present invention, the switch is a transistor. The sensor is a distance sensor, a photosensitive element, or an infrared module. The touch unit and the receiver are also disposed on the same side.

From another perspective, the present invention provides a method of operating a mobile apparatus, and the operating method is adapted for controlling a touch unit of the mobile apparatus. First, a sensor is provided, and the sensor and a receiver of the mobile apparatus are disposed on the same side. Moreover, the sensor is utilized to detect whether an object exists within a predetermined distance or not. When the sensor detects that the object is within the predetermined distance, the sensor generates a first signal to disable the touch unit.

In one embodiment of the present invention, the sensor detects whether the mobile apparatus receives a phone call before detecting whether the object is within the predetermined distance. The sensor is activated when the phone call is received.

In one embodiment of the present invention, the sensor detects the intensity of a light source, for example, to judge whether the object is within the predetermined distance.

In one embodiment of the present invention, the sensor generates a second signal to enable the touch unit when detecting that no object exists within the predetermined distance.

According to the present invention, the sensor and the receiver are disposed on the same side, such that the sensor can detect whether an object exists within a predetermined distance and generate a corresponding signal to control the touch unit. The touch unit is disabled when the object is within the predetermined distance; and the touch unit is enabled when no object is within the predetermined distance. Accordingly, operations caused by unintentional touch of the touch unit are prevented.

In order to make the aforementioned and other features and advantages of the present invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a mobile apparatus according to one embodiment of the present invention.

FIGS. 2A and 2B are block diagrams of a mobile apparatus according to one embodiment of the present invention.

FIG. 3 is a flowchart showing a method of operating a mobile apparatus according to one embodiment of the present invention.

FIG. 4 is a flowchart showing a method of operating a mobile apparatus according to another embodiment of the present invention.

### DESCRIPTION OF EMBODIMENTS

When using a conventional touch-screen mobile phone, a user may unintentionally touch the screen to activate operations while putting the phone by his ear to answer a phone call. Accordingly, the present invention provides a mobile apparatus and an operating method thereof, which utilize a sensor to control a touch unit. To make the content of the present invention more comprehensible, embodiments are described below as examples to prove that the invention can actually be realized.

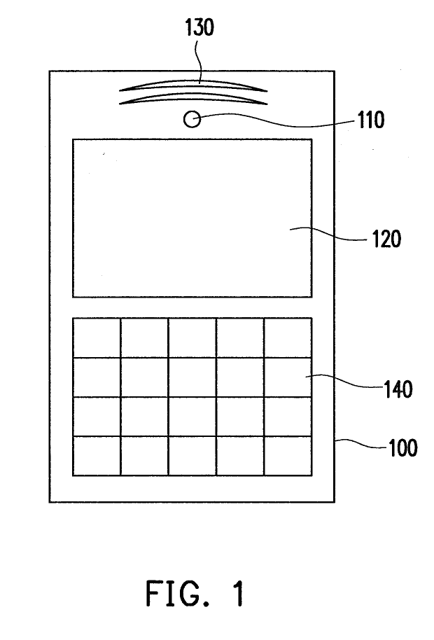

FIG. 1 is a schematic view of a mobile apparatus according to one embodiment of the present invention. Referring to FIG. 1, a mobile apparatus 100 includes a sensor 110, a touch unit 120, a receiver 130, and a keyboard 140. In this embodiment, the sensor 110 and the receiver 130 are disposed on the same side. Furthermore, the touch unit 120, the keyboard 140, and the sensor 110 are all disposed on the same side. However, in other embodiments, the keyboard 140 and the sensor 110 can be disposed on different sides of the mobile apparatus 100, or the mobile apparatus 100 may have no keyboard. The present invention does not limit the position of the keyboard 140.

The sensor 110 is used to detect whether an object exists within a predetermined distance or not, thereby generating a corresponding signal to disable or enable the touch unit 120. In other words, when the sensor 110 detects that the object is within the predetermined distance, the sensor 110 generates a first signal. When the sensor 110 detects that no object is within the predetermined distance, the sensor 110 generates a second signal.

In view of the current technology, the aforementioned mobile apparatus 100 is, for example, a mobile phone. The sensor 110 is, for example, a distance sensor, a photosensitive element, or an infrared module. The touch unit 120 is, for example, a touch screen.

Take a mobile phone equipped with a touch screen as an example, when the user draws the mobile phone close to his ear, the sensor 110 generates the first signal to disable a touch-control function of the touch screen. When the user puts the mobile phone away from his ear, the sensor 110 generates the second signal to enable the touch-control function of the touch screen.

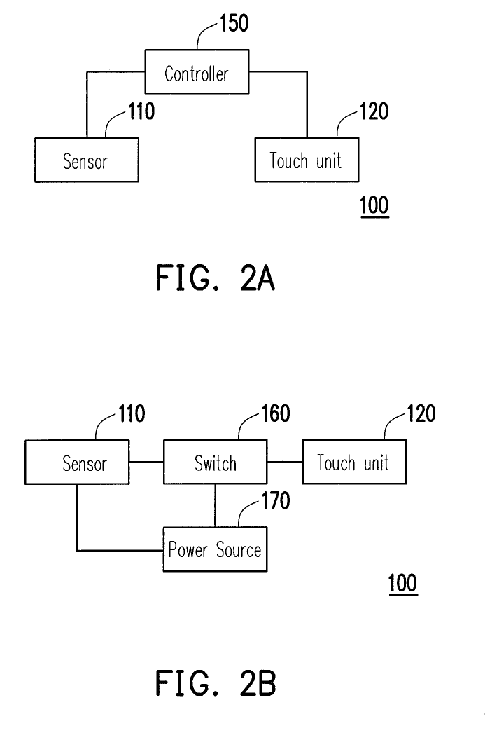

In actual application, the mobile apparatus 100 directly transmits the generated signal to a controller, by which controls the functions (such as touch-control function or display function) of the touch unit 120. In addition, the mobile apparatus 100 can transmit the generated signal to a switch for controlling the functions of the touch unit 120. Two examples of the above are given below for further explanations. FIGS. 2A and 2B are block diagrams of a mobile apparatus according to one embodiment of the present invention.

First, referring to FIG. 2A, in the mobile apparatus 100, a controller 150 is coupled between the sensor 110 and the touch unit 120. The controller 150 determines whether to disable or enable the functions of the touch unit 120 according to the signal received from the sensor 110. For instance, the controller 150 disables the touch-control function of the touch unit 120 when receiving the first signal and enables the touch-control function of the touch unit 120 when receiving the second signal.

Then, referring to FIG. 2B, a switch 160 is coupled between the sensor 110 and the touch unit 120. The touch unit 120 is coupled to a power source 170 through the switch 160. If the status of the sensor 110 changes, the switch 160 is turned on or turned off to control the power supply from the power source 170 to the touch unit 120.

For example, the switch 160 turns off a connection between the touch unit 120 and the power source 170 to disable the touch unit 120 when the switch 160 receives the first signal. The switch 160 turns on the connection between the touch unit 120 and the power source 170 to enable the touch unit 120 when the second signal is received.

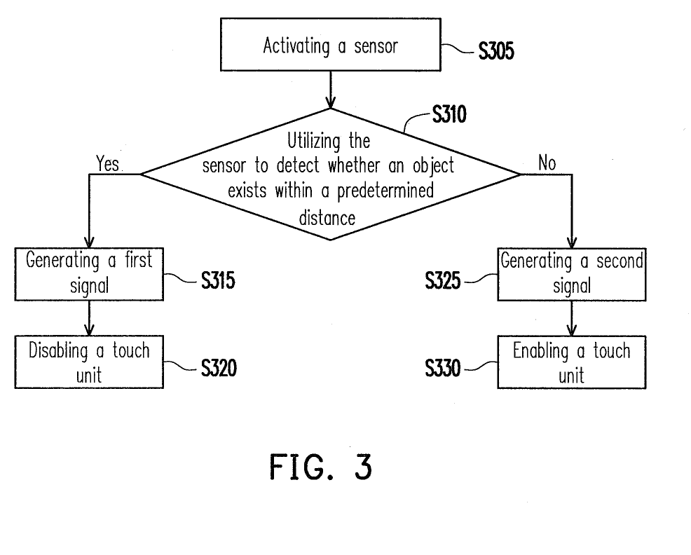

Steps of a method of operating the mobile apparatus 100 are described below with reference to the aforementioned descriptions. FIG. 3 is a flowchart showing the method of operating the mobile apparatus according to one embodiment of the present invention. Referring to FIGS. 1 and 3, in Step S305, the sensor 110 is activated first. For instance, the sensor 110 is activated when the mobile apparatus is turned on or when a particular function is activated. In a mobile phone, the sensor 110 can be set to activate when receiving a phone call.

Next, in Step S310, the sensor 110 is used to detect whether an object exists within a predetermined distance. When the sensor 110 detects that the object is within the predetermined distance, Step S315 is executed; and when no object is within the predetermined distance, Step S325 is executed. If the sensor 110 is a photosensitive element, the intensity of a light source is based on to detect whether any object is within the predetermined distance.

When the sensor 110 detects that the object is within the predetermined distance, the first signal is generated, as in Step S315. For example, a signal “1” is outputted. Thereafter, in Step S320, the touch unit 120 is disabled. Given that the touch unit 120 is already in a disabled status, the touch unit 120 remains in the disabled status. On the contrary, if the touch unit 120 is in an enabled status, the touch unit 120 would be disabled.

On the other hand, when the sensor 110 detects that no object is within the predetermined distance, the second signal is generated, as in Step S325. For example, a signal “0” is outputted. Thereafter, in Step S325, the touch unit 120 is enabled. Given that the touch unit 120 is already in the enabled status, the touch unit 120 remains in the enabled status. On the contrary, if the touch unit 120 has been disabled, the touch unit 120 would be enabled.

Referring to FIG. 2A, the sensor 110 transmits the generated signal (the first signal or the second signal) to the controller 150 first. Then, the controller 150 transmits a corresponding command (a disabling command or an enabling command) to the touch unit 120, so as to turn on or turn off the touch-control function of the touch unit 120. The foregoing step is similar to a screen lock function.

With reference to FIG. 2B, the sensor 110 transmits the generated signal to the switch 160. The switch 160 turns off or turns on the connection between the power source 170 and the touch unit 120 according to the first signal or the second signal, so as to control the power supply from the power source 170 to the touch unit 120.

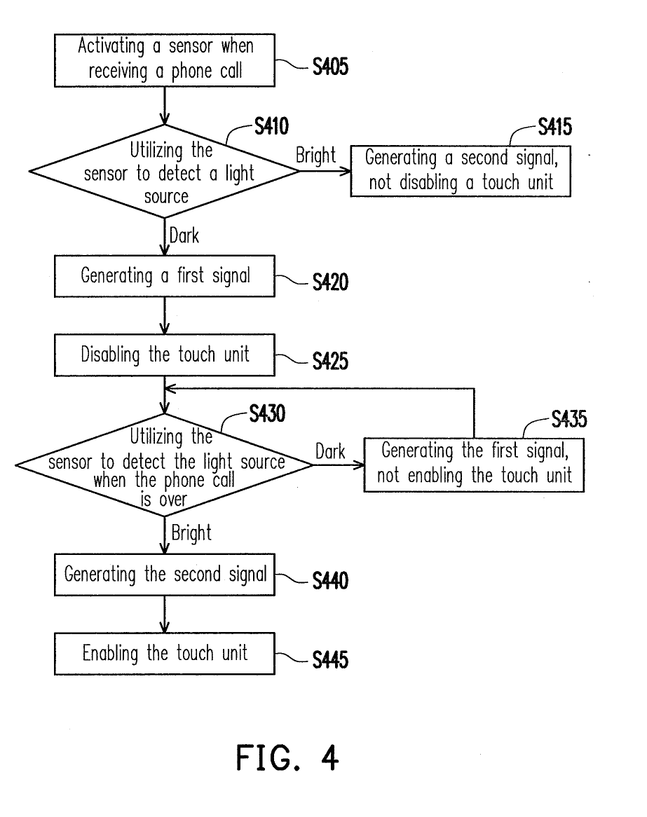

A mobile apparatus providing telephone function is given below as an example. The sensor disposed in the mobile apparatus is a photosensitive element. FIG. 4 is a flowchart showing a method of operating a mobile apparatus according to another embodiment of the present invention. Referring to FIGS. 1 and 4, first in Step S405, the sensor 110 is activated when the mobile apparatus 100 receives a phone call. For example, the sensor 110 is activated for sensing simultaneously when the user presses an answer button of the keyboard 140.

Next, in Step S410, the sensor 110 detects a light source from the environment and compares the light source with a predetermined light source. When the light source of the environment is less than the predetermined light source, the sensor 110 determines the light source of the environment as “dark” and executes Step S420. On the contrary, when the light source of the environment is greater than the predetermined light source, the sensor 110 determines the light source of the environment as “bright” and executes Step S415. The light source sensed by the sensor 110 is reduced or even blocked because the user's ear is drawn close to the mobile apparatus 100. If the user utilizes other methods, such as earphone or speaker, to answer the phone call, the sensor 110 can still sense the light source from the environment.

When the sensor 110 determines that the light source of the environment is “bright,” the sensor 110 generates the second signal and does not disable the touch unit 120, as Step S415.

When the sensor 110 determines that the light source of the environment is “dark,” the sensor 110 generates the first signal and transmits the first signal to the touch unit 120, as Step S420. Then, in Step S425, the touch unit 120 is disabled.

Thereafter, in Step S430, the sensor 110 detects the light source of the environment again to determine whether to enable the touch unit 120 when the user ends the phone call. If the sensor 110 detects that the light source of the environment is “dark,” it means that the user's ear is still nestling to the mobile apparatus 100. In Step S435, the sensor 110 generates the first signal and does not enable the touch unit 120.

When the sensor 110 detects that the light source of the environment is “bright,” it means that the user has put the mobile apparatus 100 away from his ear. In Step S440, the sensor 110 generates the second signal and transmits the second signal to the touch unit 120. Next, as shown in Step S445, the touch unit 120 is enabled.

In another embodiment, after Step S425, the sensor 110 continues detecting the light source of the environment during phone call, so as to timely enable the touch unit 120 when the user puts the mobile apparatus 100 away from his ear.

In conclusion of the above, according to the foregoing embodiments, the sensor is utilized to detect whether any object is within the predetermined distance, thereby generating a corresponding signal to control the touch unit. Accordingly, the touch unit is disabled when the user nestles to the sensor, so as to prevent the touch unit from being unintentionally touched to execute other operations.

Although the present invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A method of operating a mobile apparatus, for controlling a touch unit of the mobile apparatus, the operating method comprising:
providing a sensor, the sensor and a receiver of the mobile apparatus being disposed on the same side;
detecting whether an object exists within a predetermined distance by the sensor;
generating a first signal when the sensor detects that the object is within the predetermined distance; and
disabling the touch unit according to the first signal.

2. The operating method as claimed in claim 1, further comprising the following steps before detecting whether the object exists within the predetermined distance by the sensor:
detecting whether the mobile apparatus receives a phone call; and
activating the sensor when the phone call is received.

3. The operating method as claimed in claim 1, wherein the step of detecting whether the object exists within the predetermined distance by the sensor comprises:
detecting the intensity of a light source to judge whether the object is within the predetermined distance.

4. The operating method as claimed in claim 1, further comprising the following steps after detecting whether the object exists within the predetermined distance by the sensor:
generating a second signal when the sensor detects that there doesn't exist the object within the predetermined distance; and
enabling the touch unit according to the second signal.

5. The operating method as claimed in claim 4, wherein the touch unit provides a touch-control function and disables or enables the touch-control function according to the first signal and the second signal.

6. The operating method as claimed in claim 1, wherein the sensor comprises one of a distance sensor, a photosensitive element, or an infrared module.

7. A mobile apparatus, comprising:
a touch unit; and
a sensor coupled to the touch unit, the sensor and a receiver of the mobile apparatus being disposed on the same side;
wherein the sensor detects whether an object exists within a predetermined distance or not, the sensor generates a first signal to disable the touch unit when detecting that the object is within the predetermined distance, and the sensor generates a second signal to enable the touch unit when detecting that there doesn't exist the object within the predetermined distance.

8. The mobile apparatus as claimed in claim 7, further comprising:
a controller coupled between the touch unit and the sensor to receive the first signal and the second signal transmitted by the sensor for disabling or enabling the touch unit.

9. The mobile apparatus as claimed in claim 7, further comprising:
a switch coupled between the touch unit and the sensor to turn off a connection between the touch unit and a power source for disabling the touch unit when receiving the first signal, and to turn on the connection between the touch unit and the power source for enabling the touch unit when receiving the second signal.

10. The mobile apparatus as claimed in claim 9, wherein the switch is a transistor.

11. The mobile apparatus as claimed in claim 7, wherein the sensor comprises one of a distance sensor, a photosensitive element, or an infrared module.

12. The mobile apparatus as claimed in claim 7, wherein the touch unit provides a touch-control function and disables or enables the touch-control function according to the first signal and the second signal.

13. The mobile apparatus as claimed in claim 7, wherein the touch unit and the receiver are disposed on the same side.
